(19) United States
(12) Patent Application Publication
(10) Pub. No.: US 2014/0345578 A1
(43) Pub. Date: Nov. 27, 2014

(54) Inner Fin

(71) Applicant: Tokyo Radiator MFG. Co. Ltd., Fujikawa-shi, Kanagawa (JP)

(72) Inventor: Tetsu Yokoo, Fujisawa-shi (JP)

(73) Assignees: TOKYO RADIATOR MFG. CO., LTD., Fujisawa-shi, Kanagawa (JP); TOKYO RADIATOR MFG. CO., LTD., Fujisawa-shi, Kanagawa (JP)

(21) Appl. No.: 14/361,914

(22) PCT Filed: Nov. 22, 2012
(86) PCT No.: PCT/JP2012/080385

§ 371 Date: May 30, 2014

(30) Foreign Application Priority Data
Nov. 30, 2011 (JP) 2011-261325

(51) Int. Cl. F02M 25/07

(52) U.S. Cl. CPC F02M 25/0734
USPC 123/568.11

(57) ABSTRACT

There is provided an inner fin wherein: a sheet material is formed into an offset configuration in which grooves and ridges are formed alternately in a widthwise direction, and the grooves and the ridges are offset laterally at right angles to a gas flowing direction at predetermined length intervals in an alternate fashion; and a first projection and a second projection are formed for each segment surrounded by a pair of left and right side walls, by cutting either an upper surface portion or a lower surface portion and causing the cut surface portion to stand, the first projection being inclined towards an upstream side of the gas flowing direction, the second projection being disposed downstream of the first projection and being inclined towards a downstream side of the gas flowing direction at an angle equal to an angle at which the first projection is inclined.

### TECHNICAL FIELD

The present invention relates to an inner fin which is installed mainly in an EGR cooler in such a way as to be housed in a tube through which exhaust gases pass to thereby promote heat exchange between the exhaust gases and a cooling fluid.

### BACKGROUND ART

As an inner fin configured to be housed in a tube in an EGR cooler, there exists a conventional offset-type inner fin 9 in which a sheet material is pressed into a rectangular corrugated panel which is alternately grooved and ridged in a widthwise direction and in which the alternate grooves and ridges are offset laterally at right angles to a gas flowing direction at predetermined length intervals in an alternate fashion as shown in FIG. 5.

Additionally, in inner fins configured to be used in EGR coolers, there has been an inner fin in which in order to enhance the heat dissipating performance of a tube, ridges and grooves formed on the inner fin in a widthwise direction thereof (hereinafter, referred to as a fin pitch) are narrowed to thereby expand a heat exchanging area (Patent Document 1).

In addition, there has been an offset-type inner fin in which projections are formed on upper and lower surfaces of the inner fin so as to project into a gas flow path so that turbulence of exhaust gases are generated in the gas flow path by the projections (Patent Document 2) for the purpose of enhancing the heat dissipating performance.

### PRIOR ART DOCUMENT

### Patent Document

Patent Document 1: JP-A-2008-39380

Patent Document 2: JP-A-2010-96456

### SUMMARY OF THE INVENTION

### Problems that the Invention is to Solve

In the configuration of Patent Document 1, however, in the event that the fin pitch is narrow, a ratio at which the inner fin occupies the sectional area of the tube is large, leading to a problem that the resistance against exhaust gases flowing in the tube is large.

Additionally, since the rate at which the inner fin occupies the sectional area of the tube is large, soot, PMs (particulate matters) and the like which are contained in exhaust gases tend to be accumulated easily, and this causes the tube to be clogged, leading to a fear that the tube loses a heat exchanging function.

Further, in the event that the fin pitch is narrow, since the length of the inner fin when it is deployed becomes long, a material used for the tube is increased, resulting in an increase in material cost.

In the configuration of Patent Document 2, many of the projections are formed into the shape which is directed in the gas flowing direction (the front-to-rear direction). Then, in the event that the inner fin is assembled reversely in the front-to-rear direction in relation to the tube during fabrication, the predetermined performance cannot be exhibited.

Additionally, since the projections stand erect individually, soot and PMs which are contained in exhaust gases tend to be accumulated easily as a result of the inner fin being used for a long period of time, leading to a fear that not only is the turbulence promoting function reduced but also the heat conductivity is reduced.

The invention has been made with a view to solving the problems, and an object thereof is to provide an inner fin for a tube used in an EGR cooler which promotes the heat exchange between exhaust gases and cooling fluid, which makes it difficult for the tube to be clogged with soot and which is easy to be assembled at the time of fabrication.

### Means for Solving the Problems

In the invention, means for solving the problems described above will be as follows.

A first invention provides an inner fin configured to be installed in an EGR cooler for cooling exhaust gases, and to be used in a flat tube through which exhaust gases pass, wherein: a sheet material is formed into an offset configuration in which grooves and ridges are formed alternately in a widthwise direction, and the grooves and the ridges are offset laterally at right angles to a gas flowing direction at predetermined length intervals in an alternate fashion; and a first projection and a second projection are formed for each segment, surrounded by a pair of left and right side walls, by cutting either an upper surface portion or a lower surface portion and causing the cut surface portion to stand, the first projection being inclined towards an upstream side of the gas flowing direction, the second projection being disposed downstream of the first projection and being inclined towards a downstream side of the gas flowing direction at an angle equal to an angle at which the first projection is inclined.

That the first projection is “inclined towards an upstream side of the gas flowing direction” includes a case where the first projection is inclined either to the left or to the right at an angle less than 90 degrees in relation to the upstream direction, and that the second projection is “inclined towards a downstream side of the gas flowing direction” includes a case where the second projection is inclined at an angle less than 90 degrees in relation to the downstream direction.

A second invention is characterized in that a distance Lc between the first projection and the second projection is 0.5 time or more and 1.5 times or less a height Lh of the first projection and the second projection.

A third invention is characterized in that the first projection and the second projection are formed symmetrically with respect to a central position of the segment.

### Advantageous Effects of the Invention

According to the first invention, the sheet material is formed into the offset configuration in which the grooves and the ridges are formed alternately in the widthwise direction and the alternate grooves and ridges are offset laterally at right angles to the gas flowing direction at the predetermined length intervals in the alternate fashion, and for each segment which is surrounded by the pair of left and right side walls, the first projection and the second projection are formed, the first projection being inclined towards the upstream side of the gas flowing direction by cutting either the upper surface portion or the lower surface portion and causing the cut surface portion to stand, the second projection being disposed downstream of the first projection and being inclined towards the downstream side of the gas flowing direction at the angle equal to the angle at which the first projection is inclined. By adopting this configuration, exhaust gases flowing into the segment are made turbulent in an aggressive and promotive fashion at the first projection and are dispersed smoothly into a downstream segment by the second projection. Therefore, it is possible to enhance the heat dissipating performance of the tube without narrowing the fin pitch.

Additionally, even though soot contained in the exhaust gases is accumulated at an upstream side of the first projection which is inclined towards the upstream side as a result of the EGR cooler being used, almost no soot is accumulated at the second projection which is inclined towards the downstream side. Because of this, it is possible to suppress the reduction in heat dissipating performance of the tube to thereby extend the product life thereof.

According to the second invention, the distance Lc between the first projection and the second projection is 0.5 time or more and 1.5 times or less the height Lh of the first projection and the second projection. By adopting this configuration, the exhaust gases are made turbulent in the promotive fashion at the first projection and are dispersed smoothly at the second projection. Thus, the resulting synergetic action can make enhancing the heat dissipating performance of the tube and facilitating the formation of the inner fin compatible.

According to the third invention, the first projection and the second projection are formed symmetrically with respect to the central position of the segment. By adopting this configuration, even though the inner fin is disposed reversely in the front-to-rear direction in assembling the tube, the reduction in heat dissipating performance of the tube can be prevented, and there is no fear of an erroneous assemblage during fabrication, thereby making it possible to stabilize the quality of the tube.

### BRIEF DESCRIPTION OF THE DRAWINGS

FIG. 1 is a perspective view showing an EGR cooler which uses an inner fin according to an embodiment of the invention.

FIG. 2A is a partial perspective view of the inner fin, and FIG. 2B is a partial plan view of the inner fin.

FIG. 3A is an explanatory side view showing an interior of a segment in the inner fin, and FIG. 3B is an explanatory drawing showing a state in which the inner fin is in use.

FIG. 4 is a graph showing the results of a comparison test made on heat dissipating performance between the inner fin according to the embodiment and conventional inner fins.

FIG. 5 is a partial perspective view of a conventional inner fin.

### MODES FOR CARRYING OUT THE INVENTION

Hereinafter, an inner fin for a tube of an EGR cooler according to an embodiment of the invention will be described.

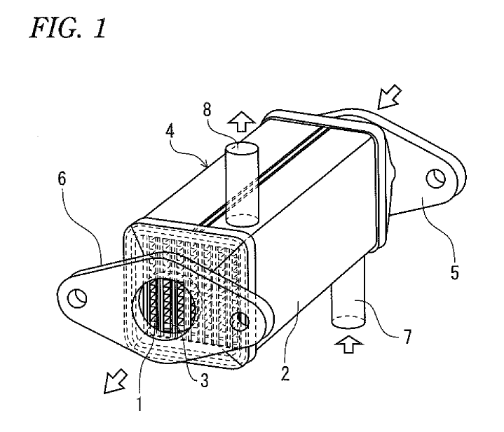

In an EGR cooler in which this inner fin 1 is used, as shown in FIG. 1, a number of flat SUS (steel special use stainless) tubes 3 are provided at predetermined intervals and are stacked together in an interior of a large-diameter angularly cylindrical shell 2 which is made up of a pair of SUS members each having a U-shaped section, whereby a core portion 4 is formed.

An SUS inlet header 5 from which exhaust gases are supplied into the tube 3 and an SUS outlet header 6 from which the exhaust gases are discharged are attached to both ends of the core portion 4 where the tubes 3 are opened.

In addition, a cooling fluid inlet pipe 7 from which a cooling fluid is supplied is connected to a lower surface portion at an inlet side of the shell 2, while a cooling fluid outlet pipe 8 from which the cooling fluid is discharged is connected to an upper surface portion at an outlet side of the shell 2.

In the core portion 4 of the EGR cooler, exhaust gases are divided into the number of tubes 3 to pass therethrough, while the cooling fluid flows through cooling fluid flow paths between the tubes 3 and the shell 2, whereby the exhaust gases are cooled through heat exchange between the exhaust gases and the cooling fluid.

The tube 3 is formed into a hollow flat tube into which a tube inner and a tube outer are assembled together, the tube inner being such that inner end walls are provided to stand erect along both side edges of a flat plate portion which is substantially flat, the tube outer being such that outer end walls are provided to stand erect along both side edges of a flat portion which is substantially flat in such a way as to externally contact the inner walls. The tube inner and the tube outer are joined together through brazing.

In this tube 3, the flat portions of the tube inner and the tube outer are swollen in a thickness direction at longitudinal ends thereof so as to form swollen portions. Because of this, when the number of tubes 3 are stacked one on another, these swollen portions are brought into abutment with the other tubes 3, to thereby provide gaps between the tubes 3 which constitute cooling fluid paths.

Each tube 3 houses an offset-type inner fin 1 not only to promote a turbulence of exhaust gases which pass through an interior of the tube 3 but also to increase a heat exchanging area between the exhaust gases and the cooling fluid, whereby the heat exchange is promoted.

The inner fin 1 is disposed between the tube inner and the tube outer when they are assembled together and is brazed to an upper surface portion and a lower surface portion of the flat plate portions of the tube inner and the tube outer.

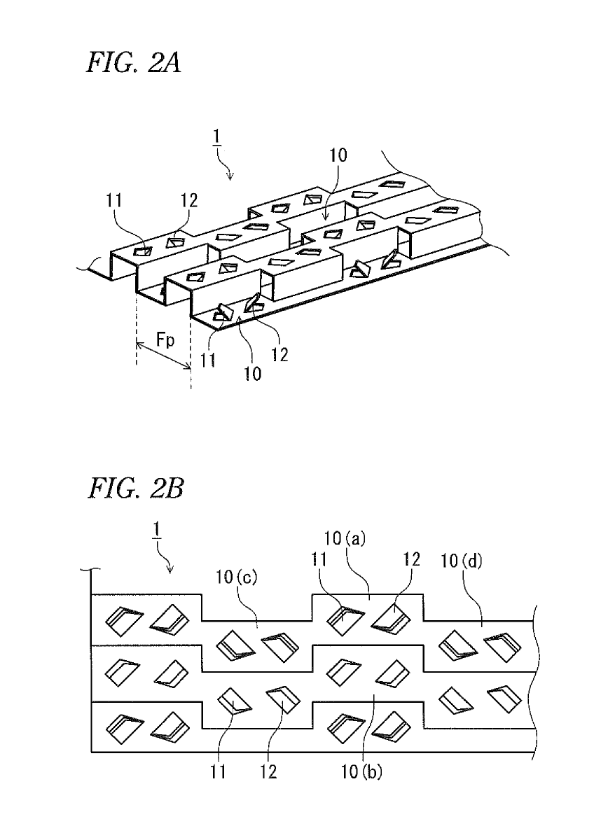

As shown in FIG. 2A, this inner fin 1 is formed into an offset configuration in which an SUS sheet material is alternately grooved and ridged in a widthwise direction (a lateral direction) and the alternate grooves and ridges are offset laterally at right angles to a gas flowing direction (a front-to-rear direction) at predetermined length intervals in an alternate fashion. An amount of lateral offsetting is set to about one fourth of a fin pitch Fp (half a width of the groove or the ridge in the widthwise direction).

By adopting this configuration, in the inner fin, a number of segments 10 which each are surrounded by a pair of left and right side walls are provided in a longitudinal direction and the widthwise direction.

As shown in FIGS. 2A and 2B, in each segment 10 of the inner fin 1, part of the upper surface portion or the lower surface portion is cut to stand, whereby a first projection 11 and a second projection 12 are formed in such a way as to project into the gas flow path.

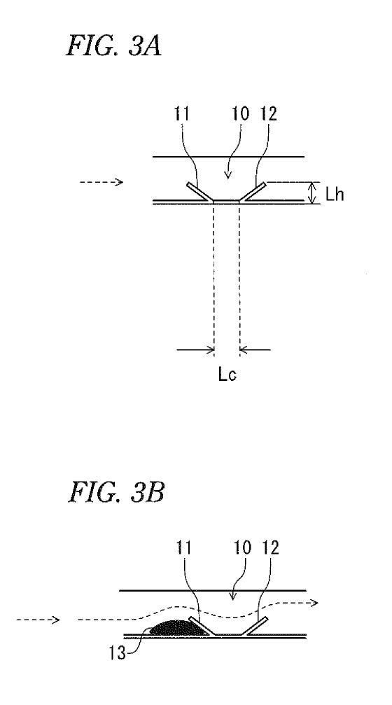

The first projection 11 and the second projection 12 are each cut to stand into a trapezoidal shape. The first projection 11 which is disposed on an upstream side of the gas flow direction is inclined towards the upstream side, while the second projection 12 which is disposed on a downstream side of the gas flow direction is inclined in an opposite direction to the direction in which the first projection is inclined, that is, towards the downstream side. Since the first projection 11 and the second projection 12 are cut to stand at an equal angle in the opposite directions as shown in FIG. 3A, as seen in FIG. 3A, the first projection 11 projects obliquely upwards to the left, and the second projection 12 projects obliquely upwards to the right.

In addition, as shown in FIG. 2B, the first projection 11 is inclined either leftwards or rightwards in relation to the gas flowing direction (the front-to-rear direction), and the second projection 12, which is disposed downstream of the first projection 11, is inclined at the same angle in an opposite direction to the direction in which the first projection is inclined either leftwards or rightwards.

As shown in FIG. 2B, in a specific segment 10a, of a first projection 11 and a second projection 12 which are formed on the lower surface portion, the first projection 11 is inclined towards the upstream side while being inclined leftwards, and the second projection 12 is inclined towards the downstream side while being inclined rightwards. As this occurs, in a segment 10b which lies laterally adjacent to the specific segment 10a, of a first projection 11 and a second projection 12 which are formed on the upper surface, the first projection 11 is inclined at the same angle towards the upstream side while being inclined leftwards, and the second projection 12 is inclined at the same angle towards the downstream side while being inclined rightwards.

On the other hand, in segments 10c, 10d which lie adjacent to the specific segment 10a at the upstream side and the downstream side, respectively, first projections 11 are inclined towards the upstream side while being inclined right wards, and second projections 12 are inclined towards the downstream side while being inclined leftwards. An angle at which the first projection 11 of the specific segment 10a is inclined leftwards in relation to the gas flowing direction is equal to an angle at which the first projection 11 of the segment 10c, 10d which lies adjacent to the specific segment 10a at the upstream side or the downstream side is inclined rightwards in relation to the gas flowing direction. Additionally, an angle at which the second projection 12 of the specific segment 10a is inclined rightwards in relation to the gas flowing direction is also equal to an angle at which the second projection 12 of the segment 10c, 10d which lies adjacent to the specific segment 10a at the upstream side or the downstream side is inclined leftwards in relation to the gas flowing direction.

The angles at which the first projections 11 and the second projections 12 are inclined laterally and the angles at which the first projections 11 and the second projections 12 are cut to stand in a height direction are adjusted so as to be optimum according to a flowing resistance of exhaust gases or a flow rate per unit time of exhaust gases of an EGR cooler used.

Arrows in broken lines in FIGS. 3A and 3B denote a flow of exhaust gases.

The first projection 11 is inclined towards the upstream side of the gas flowing direction and is shaped so as to cause aggressively a turbulence of exhaust gases flowing into the segment 10.

The second projection 12 is inclined towards the downstream side of the gas flowing direction, and therefore, the second projection 12 is configured to cause the exhaust gases which are made turbulent aggressively at the first projection 11 to flow smoothly into two segments 10 which lie downstream and leftwards and rightwards of the upstream segment 10 while being dispersed.

In addition, as shown in FIG. 3A, a distance Lc between the first projection 11 and the second projection 12 is preferably set to 0.5 time or more and 1.5 times or less a height Lh of the first projection 11 and the second projection 12.

When the distance Lc is made larger than 1.5 times the height Lh, the first projection 11 and the second projection 12 do not function in a synergetic fashion, and it is not possible to obtain the effect of dispersing at the second projection 12 smoothly the exhaust gases which are made turbulent aggressively at the first projection 11.

On the other hand, when the distance Lc is made smaller than 0.5 time the height Lh, in forming the first projections 11 and the second projections 12 in the inner fin 1, there is a fear that the first and second projections cannot be formed due to the influence of the strength of a die. The heat dissipating performance of the tube 3 can be enhanced as high as possible by setting the distance Lc as small as possible within in the range of 0.5 time to 1.5 times the height Lh.

A center between the first projection 11 and the second projection 12 coincides with a center of a segment 10, as shown in FIG. 2B, and the first projection 11 and the second projection 12 are formed symmetrically with respect to the center of the segment 10. Because of this, even though the inner fin 1 rotates horizontally through 180 degrees, in each segment 10, only the position of the first projection 11 is replaced by the position of the second projection 12 or vice versa, and hence, there is caused no change in the internal construction of the segment 10 in relation to the flow of exhaust gases.

In the tube 3 which houses the inner fin 1 configured in the way described above, exhaust gases which are dispersed to flow into each segment 10 are made turbulent by the first projection 11 which is inclined towards the upstream side and then are dispersed smoothly into the segments 10 which lie downstream by the second projection 12 which is inclined towards the downstream side. Because of this, the heat exchange between the exhaust gases and the cooling fluid is promoted, thereby making it possible to enhance the heat dissipating performance of the tube 3.

In addition, as shown in FIG. 3B, even though soot 13 which is contained in exhaust gases are accumulated on an upstream surface of the first projection 11 which is inclined towards the upstream side as a result of the EGR cooler being used, almost no soot is accumulated on the second projection 12 which is inclined towards the downstream side. Because of this, the reduction in heat dissipating performance of the tube 3 is suppressed, thereby making it possible to extend the product life thereof

In addition, by adopting the configuration in which the distance Lc between the first projection 11 and the second projection 12 is set to 0.5 time or more to 1.5 times or less the height Lh of the first projection 11 and the second projection 12, the enhancement in heat dissipating performance and the ease with which the inner fin 1 is formed can be made compatible by the synergetic action between the first projection 11 and the second projection 12.

Further, the first projection 11 and the second projection 12 are formed symmetrical with each other with respect to the center of the segment 10, and hence, even though the inner fin 1 is rotated horizontally through 180 degrees, there is caused no change in the internal construction of the segment 10 in relation to the flow of exhaust gases. Because of this, in the event that the inner fin 1 is disposed reversely in the front-to-rear direction during the fabrication of the tube 3, the heat dissipating performance of the tube 3 is not reduced, and there is no fear that an erroneous assemblage occurs during fabrication, thereby making it possible to stabilize the quality of the tube 3.

<Test>

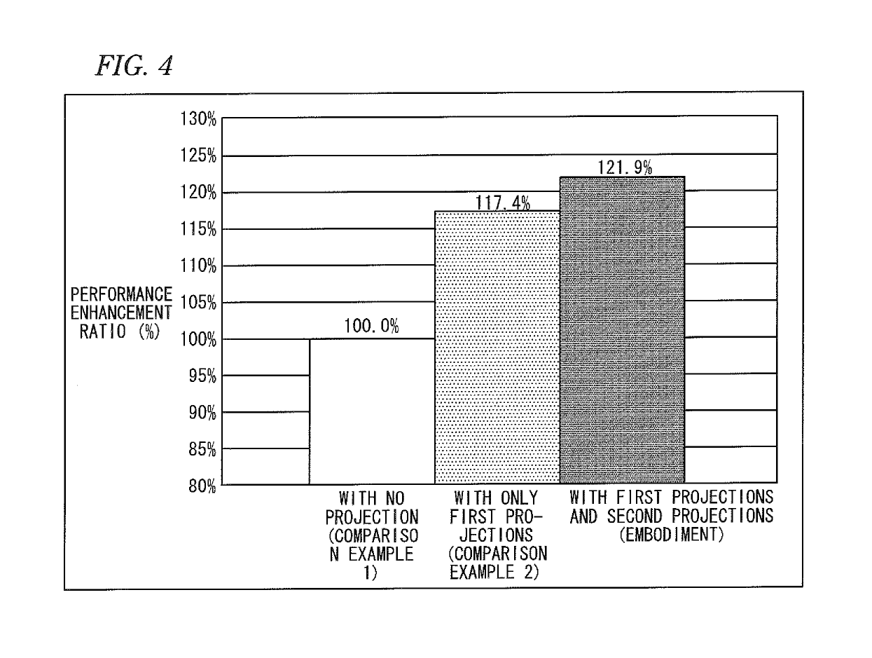

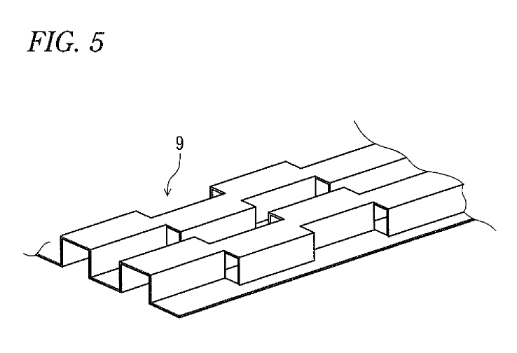

A fluid analysis was made on a tube which housed the inner fin (Embodiment) according to the embodiment of the invention, a tube which housed an inner fin (Comparison Example 1) on which neither a first projection nor a second projection is provided, as shown in FIG. 5, and a tube which housed an inner fin (Comparison Example 2) in which only a first projection was provided in each segment with no second projection provided, while causing exhaust gases to flow at a flow rate of 15 m/s during the analysis to compare heat dissipating performances of the tubes. The results are shown in FIG. 4.

Assuming that the heat dissipating amount of Comparison Example 1 is 100%, the heat dissipating amount of Comparison Example 2 is 117.4%, and the heat dissipating amount of Embodiment is 121.9%.

Consequently, it is found that the heat dissipating performance is enhanced by 21.9% in Embodiment in which the first projection 11 and the second projection 12 are both provided over Comparison Example 1 in which neither the first projection nor the second projection is provided. Additionally, it is also found that the heat dissipating performance is enhanced by about 3.8% in Embodiment over Comparison Example 2 in which only the first projection is provided in each segment.

While the invention has been described in detail and by reference to the specific embodiment, it is obvious to those skilled in the art to which the invention pertains that various alterations or modifications can be made thereto without departing from the spirit and scope of the invention.

This patent application is based on Japanese Patent Application No. 2011-261325 filed on Nov. 30, 2011, the contents of which are incorporated herein by reference.

### DESCRIPTION OF REFERENCE NUMERALS

1: inner fin; 2: shell; 3: tube; 4: core portion; 5: inlet header; 6: outlet header; 7: cooling fluid inlet pipe; 8: cooling fluid outlet pipe; 9: (conventional) inner fin; 10 (10a, 10b, 10c, 10d): segment; 11: first projection; 12: second projection: 13 soot.

1. An inner fin configured to be installed in an EGR cooler for cooling exhaust gases, and to be used in a flat tube through which exhaust gases pass, wherein:
a sheet material is formed into an offset configuration in which grooves and ridges are formed alternately in a widthwise direction, and the grooves and the ridges are offset laterally at right angles to a gas flowing direction at predetermined length intervals in an alternate fashion; and
a first projection and a second projection are formed for each segment surrounded by a pair of left and right side walls, by cutting either an upper surface portion or a lower surface portion and causing the cut surface portion to stand, the first projection being inclined towards an upstream side of the gas flowing direction, the second projection being disposed downstream of the first projection and being inclined towards a downstream side of the gas flowing direction at an angle equal to an angle at which the first projection is inclined.

2. The inner fin according to claim 1, wherein
a distance Lc between the first projection and the second projection is 0.5 time or more and 1.5 times or less a height Lh of the first projection and the second projection.

3. The inner fin according to claim 1, characterized in that
the first projection and the second projection are formed symmetrically with respect to a central position of the segment.
